(19) United States
(12) Patent Application Publication
(10) Pub. No.: US 2005/0267918 A1
(43) Pub. Date: Dec. 1, 2005

(54) System and method for bundling deployment descriptor files within an enterprise archive for fast reliable resource setup at deployment time

(76) Inventors: Andrei A. Gatev, Sofia (BG); Nikola Z. Arnaudov, Sofia (BG)

Correspondence Address: Cory G. Claassen;BLAKELY, SOKOLOFF, TAYLOR & ZAFMAN LLP, Seventh Floor, 12400 Wilshire Boulevard, Los Angeles, CA, 90025, US

(21) Appl. No.: 10/857,106

(22) Filed: May 28, 2004

(51) Int. Cl. G06F 17/30

(52) U.S. Cl. 707/203

(57) ABSTRACT

System and method to bundle deployment descriptors with enterprise archives (“EAR”). An application is bundled with at least one deployment descriptor file within an EAR. The deployment descriptor file defines properties to establish connectivity to network services. Syntax of the deployment descriptor files is verified with reference to rules definition files included within the application server. Connectivity to the network services is established based on the properties defined in the deployment descriptor files, if the syntax of the deployment descriptor files verifies as valid.

### TECHNICAL FIELD

This disclosure relates generally to software, and in particular but not exclusively, relates to automated resource setup at deployment time of applications onto application servers.

### BACKGROUND INFORMATION

The “electronization” of business processes based on Internet technologies is an increasingly popular trend to meet the growing demands of the global market. To remain competitive, businesses must optimize business processes, reduce costs, and strengthen relationships with customers, suppliers, and partners. Competitive businesses demand complex tools to quickly and efficiently collect, store, update, and communicate vital information, in real-time within a distributed computing environment. These tools must be reliable, scalable, integration compatible, capable of internationalization, and secure.

Application Servers have established themselves as one solution for overcoming these challenges. Application Servers should be designed to meet the demands of diverse needs. As such, presentation and business logic may be specially tailored to execute on Application Servers to meet the needs of a particular enterprise. The presentation/business logic may be specifically designed to access a variety of different resources, execute particular algorithms, and provide end users with customized interfaces to access and manipulate data.

Due to the diverse needs that Application Servers may service, establishing and/or renovating a large-scale enterprise environment can be costly and time-consuming. Applications containing the presentation/business logic must be deployed onto each Application Server within the enterprise environment and configured to connect to a variety of different network resources. Establishing connectivity for each application deployed on each Application Server currently requires Information Technology (“IT”) personnel to manually configure and input the properties/setting necessary to establish the desired connectivity. After each application is deployed on an Application Server, IT personnel launch consol tools (e.g., a visual administration tool or a command line tool) to input and configure connectivity to network services and resources. Accordingly, deploying a new set of presentation/business logic applications can be costly, time consuming, and prone to human error.

### SUMMARY OF INVENTION

System and method for bundling deployment descriptors and applications together within an enterprise archive (“EAR”) to streamline resource setup and configuration are described herein. An application is bundled with at least one deployment descriptor file within an EAR. The deployment descriptor file defines properties to establish connectivity to network services. The EAR is deployed onto a server node to install the application onto an application server. Syntax of the deployment descriptor files is verified with reference to rules definition files included within the application server. Connectivity to the network services is established based on the properties defined in the deployment descriptor files, if the syntax of the deployment descriptor files verifies as valid.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an enterprise environment, in accordance with an embodiment of the present invention.

FIG. 2 is a diagram illustrating an enterprise environment for deploying enterprise archives (“EAR”) having an application and deployment descriptor file bundled together, in accordance with an embodiment of the present invention.

FIG. 3 is a block diagram illustrating an application server having applications deployed thereon, in accordance with an embodiment of the present invention.

FIG. 4 is a diagram illustrating time-shared connections of a data source object using an alias, in accordance with an embodiment of the present invention.

FIG. 5 illustrates an example data source document type definition (“DTD”) file for verifying the syntax of a data source deployment descriptor file, in accordance with an embodiment of the present invention.

FIG. 6 illustrates an example alias DTD file for verifying the syntax of an alias deployment descriptor file, in accordance with an embodiment of the present invention.

FIG. 7 illustrates the hierarchical structure of a representative DTD file for verifying the syntax of a Java Messaging Service (“JMS”) Connection Factory deployment descriptor file, in accordance with an embodiment of the present invention.

FIG. 8 illustrates an example JMS Connection factory DTD file for verifying the syntax of a JMS Connection Factory deployment descriptor file, in accordance with an embodiment of the present invention.

FIG. 9 illustrates the hierarchical structure of a representative DTD file for verifying the syntax of a JMS Destination deployment descriptor file, in accordance with an embodiment of the present invention.

FIG. 10 is an example JMS Destination DTD file for verifying the syntax of a JMS Destination deployment descriptor file, in accordance with an embodiment of the present invention.

FIG. 11 is a flow chart illustrating a process to automatically setup and configure connectivity to network services using deployment descriptors bundled with an application within an EAR, in accordance with an embodiment of the present invention.

FIG. 12 is a block diagram of a demonstrative processing system to implement embodiments of the present invention.

### DETAILED DESCRIPTION

Embodiments of a system and method for automating the setup and configuration of connectivity between an application deployed onto an application server and network services are described herein. In the following description numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

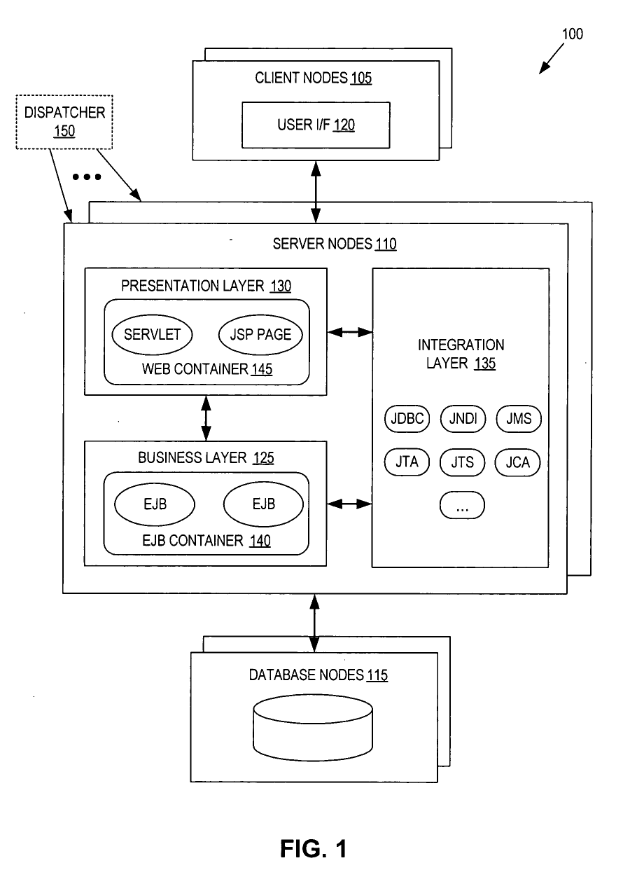

FIG. 1 is a block diagram illustrating an enterprise system 100. Enterprise system 100 is a multi-tier architecture implemented using a variety of different technologies at each sub-layer, including those based on the Java 2 Platform, Enterprise Edition™ (“J2EE”) standard (e.g., J2EE Specification, Version 1.4), the Microsoft .NET standard, the Advanced Business Application Programming (“ABAP”) standard developed by SAP AG, and the like.

Enterprise system 100 includes one or more client nodes 105 communicatively coupled to one or more server nodes 110, which are in turn communicatively coupled to one or more database nodes 115. A user interface 120 provides a graphical user interface (“GUI”) to enable users of client nodes 105 to interact with database nodes 115 (e.g., submit queries, input data, etc.) through server nodes 110. User interface 120 may be a proprietary application or a standard application, such a web browser (e.g., Internet Explorer or Netscape Navigator).

Server nodes 110 each include a business layer 125, a presentation layer 130, and an integration layer 135, which together form subcomponents of an Application Server (e.g., WebAS by SAP AG). Business layer 125 provides the business logic of the Application Server, enabling complex business processes to be implemented. In a J2EE environment, business layer 125 may include one or more Enterprise JavaBean (“EJB”) containers 140 each including one or more EJBs. The EJBs are Java based software modules (e.g., applications) that contain the actual business logic, while EJB container 140 encapsulates the EJBs in a Java based runtime environment that provides a host of common interfaces and services to the EJBs.

Presentation layer 130 describes the specific manner in which the results of business layer 125 are formatted for display on the user interface 120. The results may be formatted with aid of a web container 145 that supports both Servlets and JavaServer Pages (“JSPs”). The servlets provide server-side processing to generate the GUI and the JSPs are extensions of the Java servlet technology for providing dynamic content within the GUI.

Integration layer 135 ensures access to business functionalities from external resources. This is done using various services, connectors (middleware), communication protocols, and support for general data exchange formats (e.g., extensible markup language). For example, integration layer 135 may contain support for the following services: Java Database Connectivity (“JDBC”) Application Programming Interface (“API”), the Java Naming and Directory Interface (“JNDI”), the Java Messaging Service (“JMS”), the Java Transaction Service (“JTS”), the Java Transaction API (“JTA”), the J2EE Connector Architecture (“JCA”), and the like.

Multiple server nodes 110 may be grouped together to form a cluster of server nodes 110. A copy of the Application Server may reside on each server node 110 providing a sort of distributed environment and a redundant set of application logic and associated data. A dispatcher 150 may be provided to implement a load-balancing mechanism distributing service requests from client nodes 105 among server nodes 110 within the cluster. For example, dispatcher 150 may implement a round-robin load-balancing mechanism. Dispatcher 150 may be one of server nodes 110 having the task of dispatching service requests among server nodes 110 of the cluster.

The service requests are processed by server nodes 110 and subsequently provided to database nodes 115. Database nodes 115 offer up the requested data to server nodes 110, which in turn process and format the results for display on user interfaces 120 of client nodes 105.

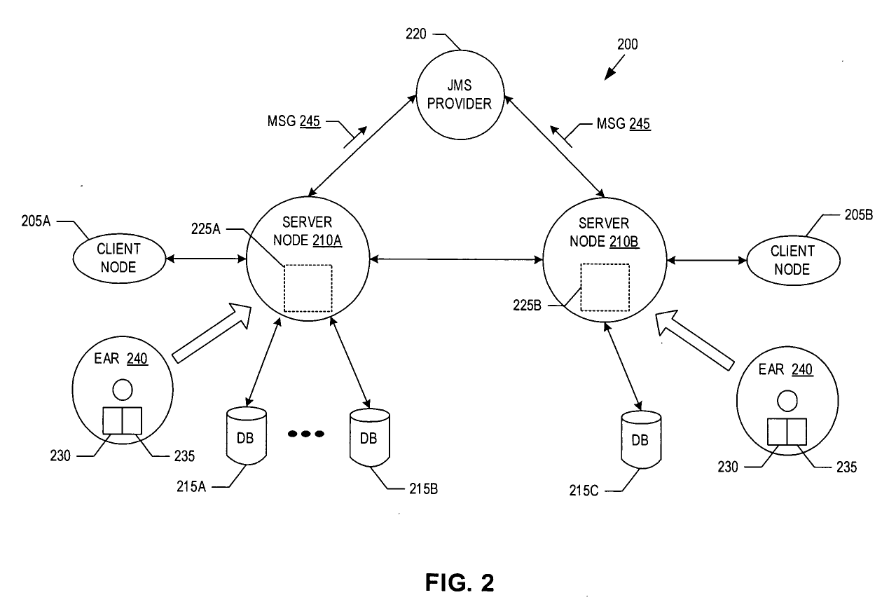

FIG. 2 illustrates an enterprise system 200 for deploying applications onto server nodes, in accordance with an embodiment of the present invention. Enterprise system 200 illustrates another perspective of enterprise system 100. The illustrated embodiment of enterprise system 200 includes client nodes 205A and 205B (collectively 205), server nodes 210A and 210B (collectively 210), database nodes 215A, 215B, and 215C (collectively 215), and a JMS Provider 220. Server nodes 210A and 210B each include an application server 225A and 225B (collectively 225), respectively, executing thereon.

Embodiments of the present invention streamline the process of deploying applications onto application servers 225 and establishing connectivity between the deployed applications and various network services. In one embodiment, applications 230 are pre-bundled with deployment descriptor (“DD”) files 235 into an enterprise archive (“EAR”) 240. Subsequently, EARs 240 are deployed onto application servers 225 to install applications 230 thereon. DD files 235 are verified by application servers 225 and then executed to automatically establish connectivity between the deployed applications 230 and various network services at the time of deployment. EARs 240 may be deployed to application servers 225 over a network link from a remote node communicatively coupled to server nodes 210 or using portable medium having EARs 240 stored thereon. Pre-bundling DD files 235 within EARs 240 ameliorates the need for an IT technician to manual configure the requisite connectivity to the network services. As such, embodiments of the present invention streamline the deployment procedure and reduce complications due to human error.

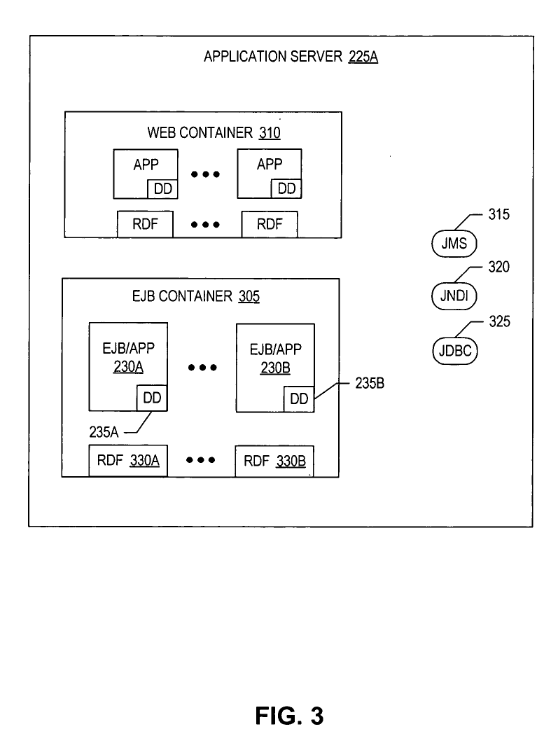

FIG. 3 is a block diagram illustrating application server 225A having applications currently deployed thereon, in accordance with an embodiment of the present invention. In one embodiment, application server 225A is similar to that described in connection with FIG. 1; however, it should be appreciated that components of application server 225A have been excluded from FIG. 3 for the purposes of clarity.

The illustrated embodiment of application server 225A includes EJB container 305, web container 310, JMS components 315, JNDI components 320, and JDBC components 325. The illustrated embodiment of EJB container 305 includes applications 230A and 230B (collectively 230) deployed thereon and having deployment descriptor (“DD”) files 235A and 235B bound thereto, respectively. The illustrated embodiment of EJB Container 305 further includes a rules definition file (“RDF”) 330. RDF 330 provides a mechanism for EJB container 305 to verify the syntax of DD files 235, prior to using DD files 235 to establish and/or configure connectivity to network services.

While RDF 330 is illustrated as internal to EJB container 305, it should be appreciated that embodiments of the present invention include RDF 330 located elsewhere within application server 225A. Furthermore, although FIG. 3 illustrates only one RDF 330 within EJB container 305 and one DD file 235 per application 230, each application 230 may include several DD files 235 and EJB container 140 may include one RDF 330 per DD file 235 of each application 230. Although embodiments of the present invention are discussed in connection with applications 230 of EJB container 140, it should be appreciated that the techniques described herein may also be applied to applications deployed into web container 310. For example, web container 310 may include one or more RDFs and applications supported within web container 310 (e.g., servlets, JSP pages, etc.) may include one or more DD files.

JMS components 315 and JDBC components 325 support two example network services through which application server 225A may communicate with remote nodes of enterprise system 200 (e.g., databases 215 and server node 210B). DD files 235 define properties needed to establish connectivity with these various network services. In one embodiment, DD files 235 are generated using an Extensible Markup Language (“XML”) to describe and define the connectivity properties. It should be appreciated that other types of Standardized General Markup Languages (“SGML”) or other languages may be used to generate DD files 235.

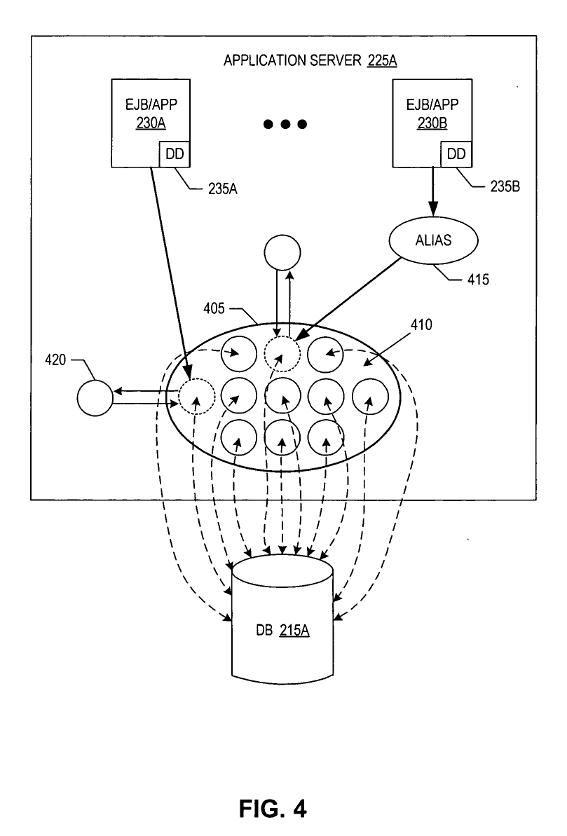

In one embodiment, one or more DD files 235 may contain configuration information to generate a data source object for establishing one or more connections to a data source (e.g., databases 215). FIG. 4 illustrates a data source object 405 having a pool of connections 410 to database 215A, in accordance with an embodiment of the present invention. In one embodiment, connections 410 are established using JDBC network services. JDBC is a programming interface that enables Java applications to communicate with a database using the Structure Query Language (“SQL”). In one embodiment, DD file 235A may be referenced upon deployment of application 230A to create data source object 405 and establish the pool of connections 410. In this embodiment, DD file 235A may include descriptor information such as, a name of database 215A, a maximum number of connections permissible, connection expiration control information, a universal resource locator (“URL”) address of database 215A, user-name information, password information and the like.

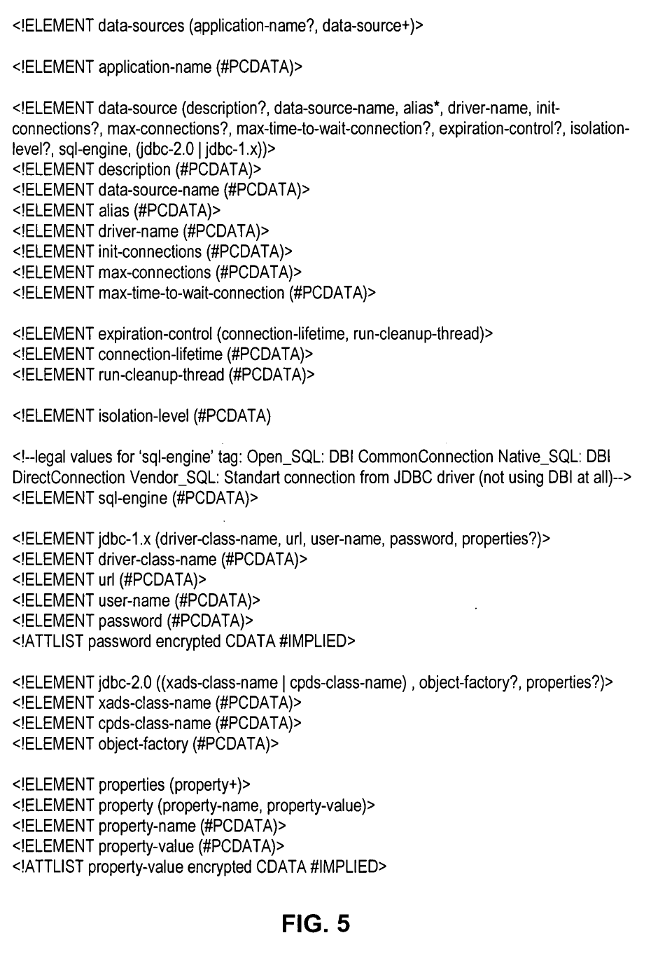

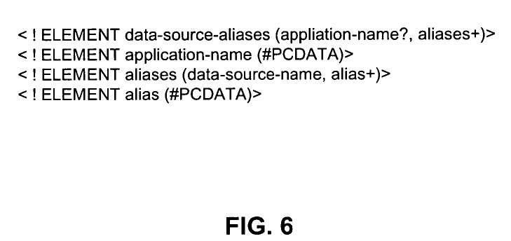

However, prior to referencing DD file 235A to create data source object 405, DD file 235A is verified with reference to RDF 330A to ensure DD file 235A does not violate syntax rules. RDFs 330 may use a number of different file format types to validate syntactic rules of DD files 235. For example, RDFs 330 may conform to a document type definition (“DTD”) file format, the XML file format, and the like. An example DTD file to verify a DD file for establishing a data source object is illustrated in FIG. 5. It should be understood that one of ordinary skill in the art having the benefit of the instant disclosure could generate a DD file if provided the corresponding DTD file.

In one embodiment, DD file 235B defines properties to establish an alias object 415 at the time of deployment of application 230B. In one embodiment, alias object 415 is created to reference data source object 405. Alias object 415 provides a mechanism to time-share the pool of connections 410. Creating a data source object to establish a new connection to database 215A is time consuming. Further database 215A may only have a limited number of connections available for all application servers 225 of enterprise system 200. Thus, if applications 230 need only sporadic communication with database 215A, time-sharing a pool of connections is more efficient than setting up and tearing down a data source object when a connection is needed. Furthermore, time-sharing connections ameliorates connection congestion due to rarely used connections occupied to the exclusion of other entities.

The pool of connections 410 are time-shared by applications 230 by borrowing an available connection of the pool of connections 410 for a period of time and then returning the borrowed connection to the pool. For example, when application 230A requires to communicate with database 215A, application 230A occupies connection 420, causing connection 420 to be removed from the pool of available connections 410. Once application 230A is finished, connection 420 is released and returned to the pool of available connections 410.

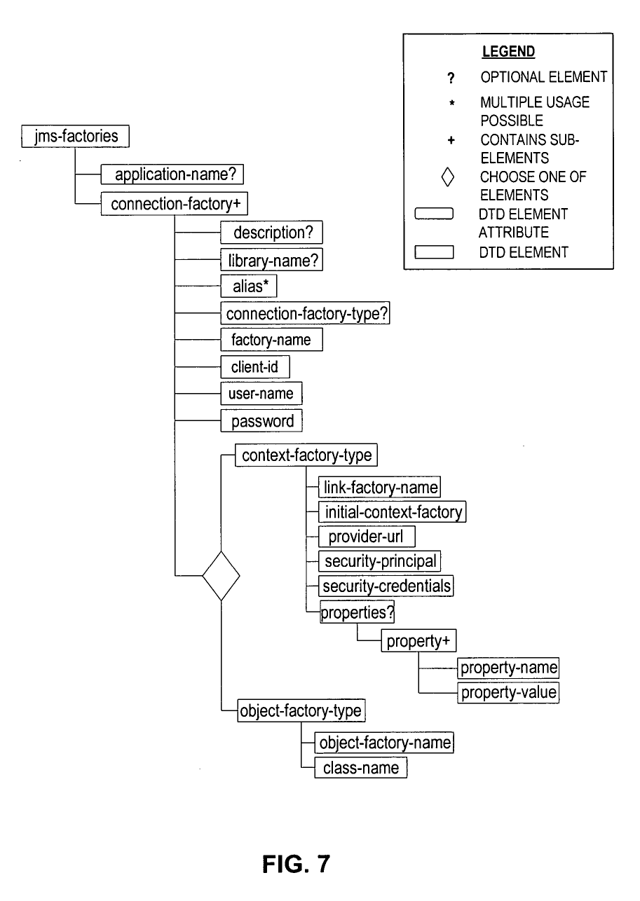

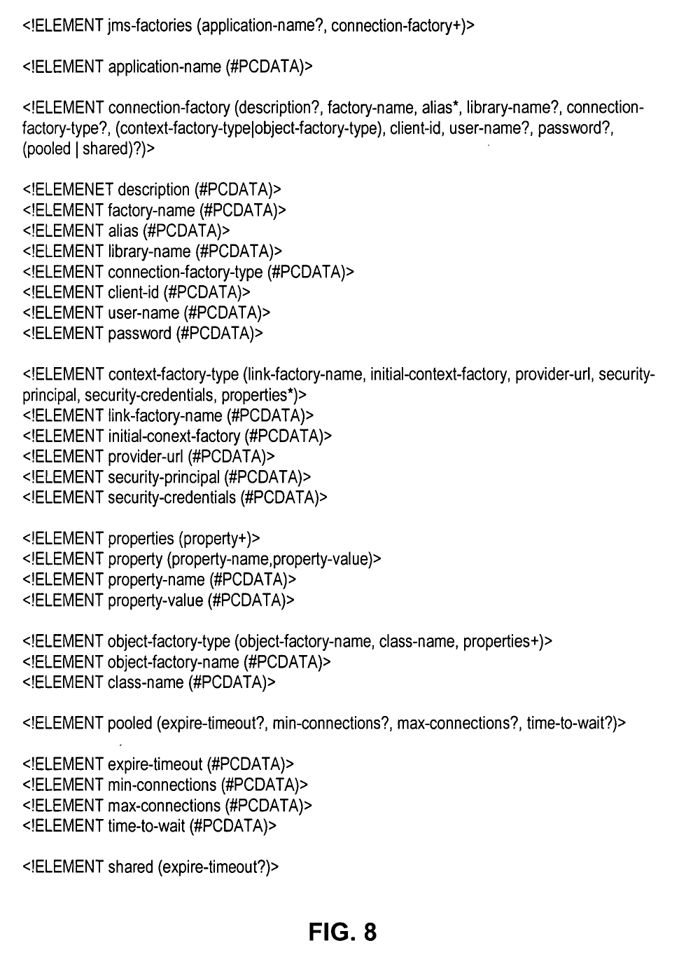

In yet other embodiments, DD files 235 may define properties to establish JMS Connectivity. JMS is a networking service that enables server nodes 210 to pass messages 245 back and forth between each other. Establishing JMS Connectivity may include creating a JMS Connection Factory Object. A JMS Connection Factory Object provides connections to JMS components 315 for communicating with remote nodes (e.g., server node 210B). FIG. 7 illustrates an example hierarchical structure of a DTD file to verify a DD file for establishing a JMS Connection Factory Object and FIG. 8 illustrates an example of such a DTD file. As can be seen from FIGS. 7 and 8, a DD file for establishing a JMS Connection Factory Object may include descriptor information, such as a name of the connection factory to be created, a connection factory type (e.g., is the connection factory a queue connection factory or a topic connection factory), a username used by JMS provider 220 and assigned to connections created by the JMS Connection Factory Object, a password corresponding to the username, and the like.

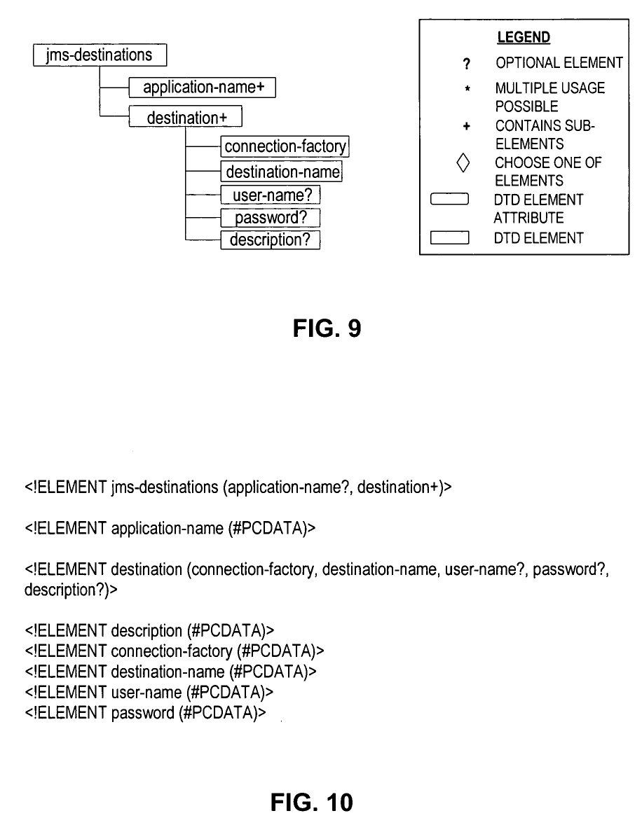

Establishing JMS Connectivity may further include creating a JMS Destination Object. A JMS Destination Object determines through which JMS provider (e.g., JMS provider 220) a message is to be routed. FIG. 9 illustrates an example hierarchical structure of a DTD file to verify a DD file for establishing a JMS Destination Object and FIG. 10 illustrates an example of such a DTD file. As can be seen from FIGS. 9 and 10, a DD file for establishing a JMS Destination Object may include descriptor information, such as a JMS destination, a reference to the JMS Connection Factory Object used to produce connections for the particular JMS destination, a username, a password associated with the username, and the like.

The process explained below is described in terms of computer software and hardware. The techniques described may constitute machine-executable instructions embodied within a machine (e.g., computer) readable medium, that when executed by a machine will cause the machine to perform the operations described. Additionally, the process may be embodied within hardware, such as an application specific integrated circuit (“ASIC”) or the like. The order in which some or all of the process blocks appear in each process should not be deemed limiting. Rather, one of ordinary skill in the art having the benefit of the present disclosure will understand that some of the process blocks may be executed in a variety of orders not illustrated.

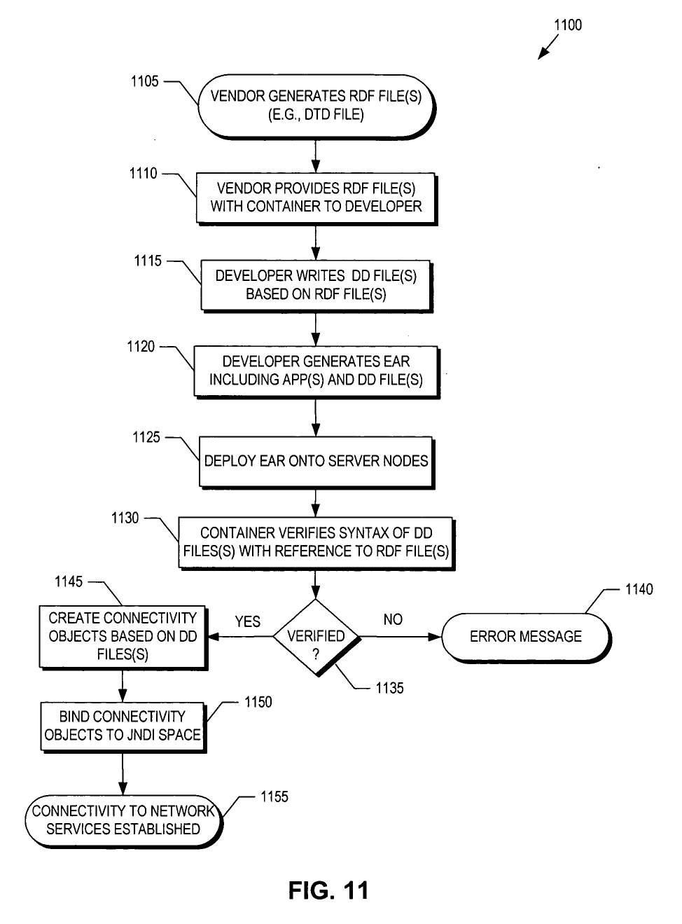

FIG. 11 is flow chart illustrating a process 1100 to automatically setup and configure connectivity to network services using DD file 235A pre-bundled with application 230A within EAR 240, in accordance with an embodiment of the present invention. Process 1100 is described in connection with application 230A, but is equally applicable to all applications 230.

In a process block 1105, a vendor generates RDF(s) 330. In one embodiment, a vendor of application servers, such as SAP, AG, Microsoft, or the like, generates RDF(s) 330A in advance to supply the syntax rules necessary to generate DD file(s) 235A for establishing connectivity to network services. In a process block 1110, the vendor inserts RDF(s) 330A into EJB container 305 and/or web container 310 and provides the modified containers to enterprise users to setup an enterprise system (e.g., enterprise systems 200). In a process block 1115, a developer of application 230A writes DD file(s) 235A based on RDF(s) 330A provided by the vendor. Subsequently, the developer pre-bundles the DD file(s) 235A with applications 230A into EAR 240 (process block 1120) for deployment on application servers 225 of enterprise system 200 (process block 1125). In one embodiment, at the time of deployment, DD file(s) 235A are copied into a known directory within server node 210 (e.g., /meta_int/) or to an underlying database from which DD file(s) 235A are accessible.

Upon deployment of an EAR 240 onto application server 225A, EJB container 305 verifies syntax of DD file(s) 235A to ensure DD file(s) 235A are not corrupt, in error, or otherwise faulty (process block 1130). EJB container 305 verifies DD file(s) 235A with reference to corresponding RDF(s) 330A. In one embodiment, a first line of DD file(s) 235A reference corresponding RDF(s) 330A against which verification is executed. In one embodiment, a verifier entity (not illustrated) reads the first line of DD file(s) 235A to determine which RDF(s) 330 to verify against. Next, the verifier entity reads in the syntactic rules provided by the referenced RDF(s) 330 and then proceeds to execute syntax verification on DD file(s) 235A. In one embodiment, the verifier entity compares tag names and positions of the tag names within DD file(s) 235 against corresponding RDF(s) 330. An example verifier entity is the Xerces Java Parser.

In one embodiment, if DD file(s) 230A do not verify valid (decision block 1135), then process 1100 continues to a process block 1140 where an error message is generated. However, if DD file(s) 235A do verify valid in decision block 1135, then process 1100 continues to a process block 1145.

In process block 1145, application server 225A applies the properties within DD file(s) 235A to create connectivity objects. These connectivity objects may include a data source object, an alias, a JMS Connection Factory object, a JMS Destination object, and the like. In some embodiments, in a process block 1150, the connectivity objects are bound to or registered with the JNDI namespace to provide other entities access to the connectivity objects. Once the connectivity objects are created and registered with the JNDI, connectivity to network services is established. Thus, pre-bundling DD file(s) 235A within EAR 240, enables application server 225A to automatically setup and configure connectivity between application 230A and network services upon deployment of EAR 240, without need of an IT personnel manually inputting the setup and configuration properties.

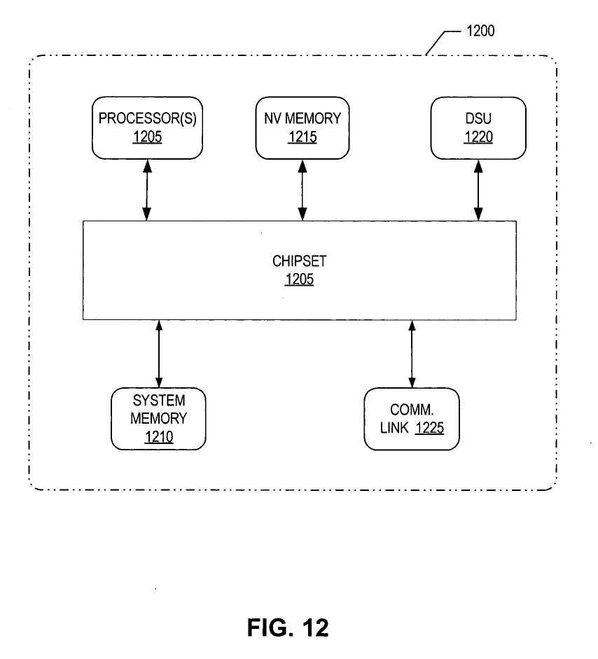

FIG. 12 is a block diagram illustrating a demonstrative processing system 1200 to implement embodiments of the present invention. The illustrated embodiment of processing system 1200 includes one or more processors (or central processing units) 1205, system memory 1210, nonvolatile (“NV”) memory 1215, a data storage unit (“DSU”) 1220, a communication interface 1225, and a chipset 1230. The illustrated processing system 1200 may represent any computing system including a client computer, a desktop computer, a notebook computer, a workstation, a handheld computer, a server, a blade server, a database, and the like. Embodiments of processing system 1200 may be used to implement one or more of client nodes 105 and 205, server nodes 110 and 210, database nodes 115 and 215, and JMS provider 220.

The elements of processing system 1200 are interconnected as follows. Processor(s) 1205 is communicatively coupled to system memory 1210, NV memory 1215, DSU 1220, and communication interface 1225, via chipset 1230 to send and to receive instructions or data thereto/therefrom. In one embodiment, NV memory 1215 is a flash memory device. In other embodiments, NV memory 1215 includes any one of read only memory (“ROM”), programmable ROM, erasable programmable ROM, electrically erasable programmable ROM, or the like. In one embodiment, system memory 1210 includes random access memory (“RAM”). DSU 1220 represents any storage device for software data, applications, and/or operating systems, but will most typically be a nonvolatile storage device. DSU 1220 may optionally include one or more of an integrated drive electronic (“IDE”) hard disk, an enhanced IDE (“EIDE”) hard disk, a redundant array of independent disks (“RAID”), a small computer system interface (“SCSI”) hard disk, and the like. Although DSU 1220 is illustrated as internal to processing system 1200, DSU 1220 may be externally coupled to processing system 1200. Communication interface 1225 may couple processing system 1200 to a network such that processing system 1200 may communicate over the network with one or more other machines (e.g., client nodes 205, server nodes 210, database nodes 215). Communication interface 1225 may include a modem, an Ethernet card, Universal Serial Bus (“USB”) port, a wireless network interface card, or the like.

It should be appreciated that various other elements of processing system 1200 have been excluded from FIG. 12 and this discussion for the purposes of clarity. For example, processing system 1200 may further include a graphics card, additional DSUs, other persistent data storage devices (e.g., tape drive), and the like. Chipset 1230 may also include a system bus and various other data buses for interconnecting subcomponents, such as a memory controller hub and an input/output (“I/O”) controller hub, as well as, include data buses (e.g., peripheral component interconnect bus) for connecting peripheral devices to chipset 1230. Correspondingly, processing system 1200 may operate without one or more of the elements illustrated.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A computer-implemented method, comprising:
deploying an enterprise archive (“EAR”) including an application and at least one deployment descriptor (“DD”) file onto an application server executing on a server node, the at least one DD file defining properties to establish connectivity to network services;
verifying syntax of the at least one DD file with reference to a rules definition file (“RDF”) included in the application server; and
establishing connectivity to the network services based on the properties defined in the DD file, if the syntax of the DD file verifies as valid.

2. The method of claim 1, wherein establishing connectivity to the network services based on the properties defined in the DD file comprises:
generating connectivity objects based on the DD file; and
binding the connectivity objects into a Java Naming and Directory Interface (“JNDI”) namespace to provide access to the connectivity objects.

3. The method of claim 2, further comprising:
communicating with a remote node coupled to the server node via a communication link using the network services.

4. The method of claim 1, wherein the DD file comprises an extensible markup language (“XML”) file.

5. The method of claim 4, wherein the RDF conforms to a document type definition (“DTD”) file format.

6. The method of claim 1, wherein the at least one DD file defines properties to establish a Java Database Connectivity (“JDBC”) connection to access a remote database node.

7. The method of claim 1, wherein the at least one DD file defines properties to establish connectivity to a Java Messaging Service (“JMS”).

8. The method of claim 7, wherein the at least one DD file defines properties to establish a JMS Connection Factory.

9. The method of claim 7, wherein the at least one DD file defines properties to establish a JMS Destination object.

10. The method of claim 1, wherein the at least one DD file defines at least one alias pointing to a data source object to provide connections to a remote node communicatively coupled to the server node, the at least one alias to time-share the connections.

11. The method of claim 1, wherein the application server comprises one of a Java 2 Enterprise Edition (“J2EE”) application server and a .NET application server.

12. A machine-accessible medium that provides instructions that, if executed by a machine, will cause the machine to perform operations comprising:
executing an application server to receive an application and to provide network services to the application, the application server including at least one rules definition file (“RDF”), the RDF to verify syntax of a deployment descriptor (“DD”) file defining properties to establish connectivity between the application and network services;
receiving the application along with the DD file deployed from an enterprise archive (“EAR”); and
verifying the syntax of the DD file with reference to the RDF.

13. The machine-accessible medium of claim 12, further providing instructions that, if executed by the machine, will cause the machine to perform further operations, comprising:
providing the network services to the application based on the properties defined in the DD file, if the verifying with reference to the RDF verifies the syntax of the DD file as valid.

14. The machine-accessible medium of claim 13, wherein the RDF defines syntax of an extensible markup language (“XML”) deployment descriptor file.

15. The machine-accessible medium of claim 14, wherein the RDF conforms to a document type definition (“DTD”) file format.

16. The machine-accessible medium of claim 13, wherein the RDF includes information to verify syntax of a Java Messaging Service (“JMS”) Destination descriptor file.

17. The machine-accessible medium of claim 16, wherein the information includes syntax rules for a JMS destination descriptor, a name of an associated JMS Connection Factory descriptor, a username descriptor, and a password descriptor.

18. The machine-accessible medium of claim 14, wherein the RDF includes information to verify syntax of a data source descriptor file for establishing a Java DataBase Connectivity (“JDBC”) interface to a database.

19. The machine-accessible medium of claim 18, wherein the information includes syntax rules for a data source name descriptor, a connection expiration control descriptor, and a maximum number of connections descriptor.

20. The machine-accessible medium of claim 14, wherein the RDF includes information to verify syntax of a Java Messaging Service (“JMS”) Connection Factory descriptor file.

21. The machine-accessible medium of claim 20, wherein the information includes syntax rules for a factory-name descriptor and a connection-factory-type descriptor.

22. The machine-accessible medium of claim 14, wherein the RDF includes information to verify syntax of a data source alias descriptor file to enable time-sharing of data source connections to a database.

23. The machine-accessible medium of claim 12, wherein the application server comprises one of a Java 2 Enterprise Edition (“J2EE”) application server and a .NET application server.

24. An application server, comprising:
an application to provide business logic to an enterprise environment;
network services to provide the application access to remote nodes within the enterprise environment;
a deployment descriptor (“DD”) file bound to the application to configure connectivity between the application and the network services; and
a container to encapsulate the application within a runtime environment, the container including a rules definition file (“RDF”), the RDF to verify syntax of the DD file upon deployment of the application and DD file.

25. The application server of claim 24, wherein the DD file comprises an extensible markup language (“XML”) deployment descriptor file.

26. The application server of claim 24, wherein the RDF conforms to a document type definition (“DTD”) file format.

27. The application server of claim 24, wherein the DD file is to configure connectivity between the application and a Java Messaging Service (“JMS”).

28. The application server of claim 27, wherein the DD file is further to establish a JMS Connection Factory.

29. The application server of claim 27, wherein the DD file is further to establish a JMS Destination Object.

30. The application server of claim 24, wherein the DD file is to establish a data source object and configure Java Database Connectivity (“JDBC”) connections between the data source object and one of the remote nodes.

31. The application server of claim 30, further comprising:
another DD file bound to the application to establish an alias pointing to a data source object, the alias to time-share the JDBC connections; and
another RDF included within the container, the another RDF to verify the syntax of the another DD file.

32. The application server of claim 24, wherein the application server comprises a Java 2 Enterprise Edition (“J2EE”) application server.

33. A system, comprising:
means for providing business logic to an enterprise environment;
means for automatically configuring network connectivity between the means for providing business logic and remote nodes within the enterprise environment; and
means for verifying syntax of the means for automatically configuring.

34. The system of claim 33, further comprising:
means for encapsulating the means for providing the business logic within an runtime environment, wherein the means for verifying the syntax is bound to the means for encapsulating.

35. The system of claim 34, further comprising:
means for deploying the means for providing the business logic into the means for encapsulating, wherein the means for deploying includes the means for providing the business logic bundled with the means for automatically configuring the network connectivity.

36. The system of claim 35, wherein the means for deploying comprises an enterprise archive (“EAR”), the means for providing the business logic comprises a business application, and the means for automatically configuring the network connectivity comprises a deployment descriptor file.

37. An enterprise archive, comprising:
an application including one of business logic and presentation logic to deploy onto an application server; and
a deployment descriptor (“DD”) file defining properties to establish connectivity between the application and network services after deployment to the application server, the syntax of the DD file automatically verifiable with reference to a rules definition file (“RDF”) includable with the application server.

38. The enterprise archive of claim 37, wherein the application comprises one of an Enterprise Java Bean (“EJB”), a Servlet, and a Java Server Page (“JSP”).

39. The enterprise archive of claim 37, wherein the DD file comprises an extensible markup language (“XML”) deployment descriptor file.

40. The enterprise archive of claim 37, wherein the DD file defines properties to configure at least one of a connection to a Java Messaging Service (“JMS”), a Java DataBase Connectivity (“JDBC”) connection to a database, and an alias pointing to a data source including multiple network connections for time-sharing the network connections.
